(19) United States
(12) Patent Application Publication
(10) Pub. No.: US 2024/0018951 A1
(43) Pub. Date: Jan. 18, 2024

(54) Chemical-Microwave-Electrothermal Thruster

(71) Applicant: MOMENTUS SPACE LLC, San Jose, CA (US)

(72) Inventors: David Robert Buckley Biggs, Palo Alto, CA (US); Michael Werner Georg Winter, San Jose, CA (US); Joseph Mark Oorebeek, Palo Alto, CA (US); Robert Erik Schwarz, Los Gatos, CA (US); Charles Jonathan Chase, Savannah, GA (US)

(21) Appl. No.: 17/863,180

(22) Filed: Jul. 12, 2022

(51) Int. Cl. F02K 9/68; F03H 1/00; F02K 9/42

(52) U.S. Cl. CPC F02K 9/68; F03H 1/0012; F02K 9/425

(57) ABSTRACT

A thruster system for use in a spacecraft combines chemical and electric or electrothermal propulsion. To that end a thruster may comprise a cavity including at least one inlet to receive a first fluid and a second fluid configured to chemically react with the first fluid within the cavity to generate a reaction product. Alternatively, the cavity may be configured to receive a monopropellant configured to chemically decompose within the cavity. The thruster system further comprises an energy source coupled to the cavity and configured to heat or ionize material within the cavity by emitting electromagnetic radiation. Still further, the thruster system comprises a nozzle provided at one end of the cavity and configured to direct heated material out of the cavity to generate thrust.

### FIELD OF THE INVENTION

The present disclosure relates to a thruster system of a spacecraft and, more particularly, to combining chemical and electrothermal propulsion techniques.

### BACKGROUND

With increased commercial and government activity in Near Space, a variety of spacecraft and missions are under development. For example, a spacecraft may be dedicated to delivering payloads such as satellites from one orbit to another, cleaning up space debris, making deliveries to space stations, etc. In the course of such missions, managing the propellant and solar energy efficiently remains a challenge.

Furthermore, during the course of such missions, a number of different maneuvers, such as orbital insertion, orbital transfer, and orbital correction, may be performed. A number of different thruster technologies may have characteristics (with respect to thrust, specific impulse, etc.) that are better suited to different types of maneuvers.

Generally, in addition to operational requirements, spacecraft-based systems may need to satisfy weight and space constraints. That is, all of the systems may need to fit into specified mass and volume envelopes. Furthermore, proliferation of subsystems and components may increase the probability of failure. Thus, there is a need for flexible thruster technologies that reduce mass, space, and/or complexity while improving energy efficiency and/or speed for a variety of different maneuvers.

The state of the art of spacecraft propulsion consists of primarily two types of systems: chemical and electric. Spacecraft that use the former typically are limited to less demanding orbital transfer missions due to low specific impulse. On the other hand, spacecraft that use the latter suffer from exceedingly long mission durations due to low thrust.

### SUMMARY OF THE INVENTION

Presently, a thruster system and associated methods combining chemical and electrothermal propulsion are disclosed.

In one embodiment, a thruster system for use in a spacecraft comprises a cavity including at least one inlet to receive a first fluid and a second fluid configured to chemically react with the first fluid within the cavity to generate a reaction product. The thruster system further comprises an energy source coupled to the cavity and configured to heat content of the cavity by emitting electromagnetic radiation. Still further, the thruster system comprises a nozzle provided at one end of the cavity and configured to direct the heated content out of the cavity to generate thrust.

In another embodiment, the thruster system for use in a spacecraft comprises a cavity including at least one inlet to receive a monopropellant configured to chemically decompose within the cavity to generate a plurality of decomposition products. The thruster system further comprises an energy source coupled to the cavity and configured to heat content of the cavity by emitting electromagnetic radiation. Still further, the thruster system comprises a nozzle provided at one end of the cavity and configured to direct at least one of the plurality of decomposition products out of the cavity to generate thrust.

In yet another embodiment, a method of spacecraft propulsion comprises receiving at a cavity via at least one inlet a first fluid and a second fluid configured to chemically react with the first fluid within the cavity to generate a reaction product. The method further comprises heating, by electromagnetic radiation emitted by an energy source coupled to the cavity, content of the cavity. Still further, the method comprises directing, via a nozzle, the heated content out of the cavity to generate thrust.

### BRIEF DESCRIPTION OF THE DRAWINGS

FIG. 1A and FIG. 1B illustrate a distinction between a conventional thruster system based on microwave-electrothermal (MET) propulsion and an example thruster system based on chemical-MET propulsion.

FIG. 2 schematically illustrates an example embodiment of a chemical decomposition unit using proton exchange membrane (PEM) electrolysis.

FIG. 3 schematically illustrates an example embodiment of a chemical decomposition unit using high temperature electrolysis.

FIG. 4 schematically illustrates a second example embodiment of a thruster system based on chemical-MET propulsion.

FIG. 5 schematically illustrates a third example embodiment of a thruster system based on chemical-MET propulsion.

FIG. 6 schematically illustrates a fourth example embodiment of a thruster system based on chemical-MET propulsion.

FIG. 7 schematically illustrates a fifth example embodiment of a thruster system based on chemical-MET propulsion.

FIG. 8 is a block diagram of an example spacecraft, configured for transferring a payload between orbits, in which any of the thruster system embodiments of this disclosure may operate.

FIG. 9 illustrates an example method of spacecraft propulsion using a combination of electrothermal and chemical propulsion.

### DETAILED DESCRIPTION

The thruster systems and associated methods of this disclosure may reduce weight, space, and/or complexity of spacecraft while improving energy efficiency and/or speed for a variety of different maneuvers. The thruster systems of this disclosure combine chemical and electrothermal propulsion in a synergistic manner, i.e., such that the chemical and electrothermal processes enhance one another. In this combined/hybrid thruster, energy released during chemical reactions may aid in gas ionization. Conversely, ionization of gases by breakdown using electromagnetic radiation may accelerate, control, and/or confine chemical reactions to produce thrust.

Some thruster systems of this disclosure convert electrical energy into kinetic energy more efficiently by chemically breaking down (with the aid of electrical energy, e.g., by electrolysis) a propellant prior to injecting the chemical components of the propellant into a thruster. This use of electrolysis to enhance a microwave-electrothermal (MET) thruster may provide greater than 70% thruster efficiency, as compared to conventional MET thrusters that typically have about 50% thruster efficiency.

Furthermore, the disclosed techniques may make more efficient use of solar power collection components (e.g., solar panels). For example, whereas some conventional thrusters might fail to make use of solar power collected when the thruster is not firing, the disclosed techniques may continue to use solar power to power an electrolysis unit that chemically decomposes propellant.

Further still, chemical energy may be released more quickly (e.g., by combustion), providing more power than electrothermal combustion alone, potentially increasing orbital transfer efficiency. The orbital transfer efficiency improvements may be particularly beneficial for entering certain orbits, such as elliptical orbits with high apogee. Importantly, generation of plasma within the thruster prior to, simultaneous with, and/or after the injection of reactants may further improve the efficiency of chemical reactions to generate high thrust.

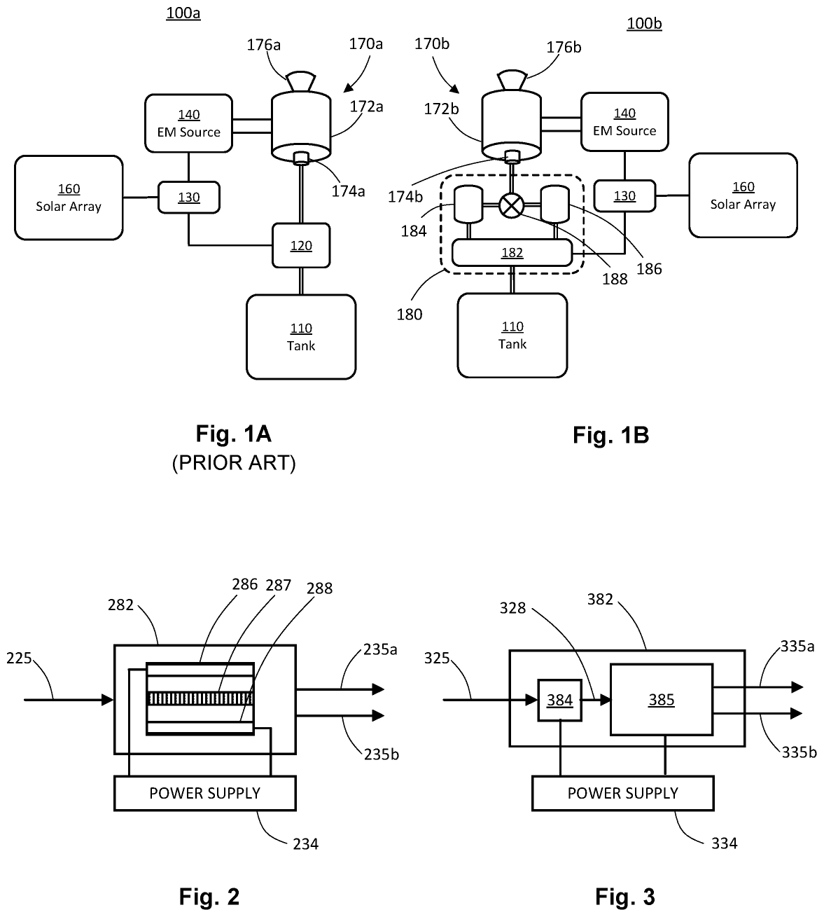

FIGS. 1A, B illustrate a distinction between a conventional thruster system 100a based on microwave-electrothermal (MET) propulsion and an example thruster system 100b of the present disclosure. The example thruster system 100b is configured to combine (or at least, to have a mode of operation that combines) chemical/combustion-based and MET-based propulsion. In some embodiments, such a combination may be thought of as plasma-enhanced chemical propulsion (e.g., based on combustion or other oxidation-reduction reactions). In other embodiments, the combination may be thought of as combustion-enhanced MET. Generally, a thruster system of the present disclosure, combining MET thruster operating mode with the injection of chemical reactants, may be referred to as a chemical-MET thruster system.

Each of the thruster systems 100a, b includes a tank 110 configured to store propellant in solid, liquid, or gaseous form. The propellant may be any suitable material, and any reference in the present disclosure to the material stored in the tank 110 as the “propellant” refers solely to the fact that the material and/or its derivatives are used for propulsion. The conventional thruster system 100a may also include a conversion unit 120 configured to convert the propellant stored in the tank 110 from one phase into another. For example, the conversion unit 120 may include a pump and/or a vaporizer configured to convert liquid propellant into a gaseous phase. In some embodiments, the thruster system 100b does not include any such conversion unit. Each of the systems 100a, b may include an electrical power unit 130, a source of electromagnetic energy 140 (referred to herein as an electromagnetic or EM energy source 140, or simply source 140), a solar array 160, and a respective thruster 170a or 170b. Each of the thrusters 170a, b includes a respective cavity 172a, b, a respective inlet 174a, b, and a respective nozzle 176a, b. While the thruster 170a typically includes one inlet (i.e., 174a), thruster 170b may include a plurality of inlets (e.g., separate inlets for different fluids). The thruster 170a may be referred to herein as a MET thruster 170a.

In thruster system 100a of FIG. 1A, the thruster 170a, the tank 110, and the conversion unit 120a are in fluidic communication with each other. In operation, the thruster in the system 100a may receive, via the inlet 174a, propellant from the tank 110. Before entering the cavity 172a via the inlet 174a, the propellant from the tank 110 may pass through the conversion unit 120. For example, the tank 110 may store water in liquid form and the conversion unit 120 may vaporize the water. The water entering the cavity 172a may then take the form of water vapor or steam.

In the embodiment of FIG. 1B, the thruster system 100b includes, instead of the conversion unit 120, a conversion unit 180 which is in fluidic communication with the tank 110 and the thruster 170b. In turn, the conversion unit 180 may include a chemical decomposition unit 182, accumulation tanks 184, 186, and a combiner 188 in fluidic communication with each other. In some embodiments, the accumulation tanks 184 and 186 may be in direct fluidic communication with the cavity 172b via distinct inlets, omitting the combiner 188. The fluidic conduits between the tanks 184 and 186 and the cavity 172b may include valves controlled by a controller, as discussed in more detail below with reference to FIG. 5. The chemical decomposition unit 182 may be configured to generate a plurality of fluids of different molecular compositions from the propellant or any suitable source material stored in the tank 110. For example, the source material may be water (decomposable into hydrogen and oxygen), hydrazine (decomposable into ammonia, and then further into nitrogen and hydrogen), ammonia (decomposable into hydrogen and nitrogen), carbon dioxide (decomposable into oxygen and carbon monoxide), or another suitable source material. The accumulation tank 184 may store a first fluid, which is a product of the chemical decomposition performed in the decomposition unit 182. Similarly, the accumulation tank 186 may store a second fluid, which is a different product of the chemical decomposition performed in the decomposition unit 182.

In operation, the combiner 188 may direct the first fluid and the second fluid into the thruster 170b. The cavity 172b may receive the first fluid and the second fluid from the combiner 188 via the inlet 174b. In some embodiments or operation modes, the combiner 188 may direct the first fluid and the second fluid into the cavity 172b sequentially, i.e., first the first fluid and then the second fluid. In other embodiments or operation modes, the combiner 188 may direct both fluids into the cavity 172b simultaneously. In some embodiments, the cavity 172b may receive the first fluid and the second fluid directly from the chemical decomposition unit 182 by way of one inlet (e.g., inlet 174b), or by way of a different inlet for each fluid. Some embodiments omit accumulation tanks (e.g., tanks 184, 186) and/or or combiners (e.g., combiner 188), e.g., if the chemical decomposition unit 182 feeds the fluid products directly into the cavity 172b via one or more inlets.

In operation of the thruster system 100b, the first fluid and the second fluid may be configured to chemically react to generate a reaction product within the cavity 172b. The chemical reaction between the two fluids may be endothermic or exothermic. For example, the chemical reaction may be an exothermic combustion reaction. Furthermore, the reaction may require an energy input to overcome the activation energy of the reaction. Further still, the reaction may use catalysis, with a catalyst disposed within the cavity 172b. In some embodiments, at least one of the products of the reaction may have the chemical composition of the propellant stored in the tank 110.

In both thruster systems 100a, b, the electrical power unit 130, the source of electromagnetic energy 140, and the solar array 160 are in electrical communication with each other. In operation, the solar array 160 may charge the electrical power unit 130, which in turn provides electrical energy to the source 140. The electrical power unit 130 may include a battery that is configured to provide direct current (DC) to the electromagnetic source 140. The electromagnetic source 140 is in turn electrically coupled to the cavity 172a in system 100a or the cavity 172b in system 100b via, for example, a transmission line or a waveguide. The electromagnetic source 140 may be configured to generate electromagnetic energy as radio wave radiation of a suitable frequency (e.g., in the range of 10 kHz to 100 GHz) and with any suitable envelope and/or modulation (e.g., continuous-wave, pulsed, amplitude modulated, and/or frequency modulated). For example, the electromagnetic source may be pulsed with a repetition frequency between 10 Hz to 100 MHz and a duty cycle between 0.01 to 99%. The electromagnetic source 140 may be configured to deliver the generated energy to the cavity 172a or the cavity 172b by way of a waveguide or a transmission line. To that end, the cavities 172a, b may include one or more slots or antennas terminating waveguides or transmission lines from the respective source 140. The cavities 172a, b may be configured as resonant cavities for one or more frequencies of the EM energy emitted by the respective source 140. The EM energy emitted by the respective source 140 may accumulate in the cavities 172a, b, for example according to a pattern of a resonant mode. For suitable resonant modes, the energy in the cavity (e.g., the cavities 172a, b) may have a peak near the cavity center away from the cavity walls. Furthermore, the cavity (e.g., the cavities 172a, b) may be configured to have a mode peak suitably near the nozzle (e.g., nozzle 176a, b).

In operation, material injected into cavities 172a, b may absorb EM energy emitted by the respective source 140. In thruster system 100a, the propellant from the tank 110, converted into vapor by the conversion unit 120 and injected into the cavity 172a, may absorb the EM energy and convert the EM energy into kinetic energy of the propellant ejected through the nozzle 176a. In thruster system 100b, in contrast, either the first fluid, the second fluid, or any of the chemical products of the reaction between the first and the second fluid may absorb the EM energy, converting it to thermal or kinetic energy.

In some embodiments of the thruster system 100b, the first fluid, the second fluid, or both may ionize under the EM radiation to form plasma. The resulting plasma may accelerate the absorption of the EM radiation emitted by the source 140 of the thruster system 100b and kinetically transfer the heat to the first fluid, the second fluid, and/or one or more of the reaction products. Additionally or alternatively, one or more of the reaction products may ionize under the EM radiation to form plasma. The EM energy absorbed by the resulting plasma may similarly transfer to any of the materials injected into the cavity 172b.

In some embodiments of the thruster system 100b, the cavity 172b may initially receive an amount of the first fluid. The received amount may form a suitable pressure in the cavity 172b to facilitate plasma formation under the EM radiation emitted from the source 140. An amount of the second fluid may then be introduced to the cavity 172b (possibly with an additional amount of the first fluid) to cause a chemical reaction. In other embodiments, the cavity 172b may simultaneously receive amounts of both the first fluid and the second fluid to cause a chemical reaction. In either case, the heat of the chemical reaction may then aid in the formation of the plasma while the thruster system 100b increases the EM energy emitted by source 140.

One or more inlets (e.g., inlet 174b) may inject the first fluid and/or the second fluid to create circumferential flow to aid in stabilizing and/or confining the plasma in the cavity 172b. For example, during a portion of an operating sequence, the first fluid may be the fluid predominantly ionized to form plasma, while the second fluid may be the predominant fluid in the circumferential flow stabilizing the plasma. More generally, the thruster system 100b may cause any one or more of the first fluid, the second fluid, or the chemical product to ionize to form plasma, while causing any one or more of the first fluid, the second fluid, or the chemical product to flow circumferentially in the cavity 172b to stabilize or confine the resulting plasma.

Additionally or alternatively, in thruster system 100b, the EM energy emitted by the source 140 may accelerate the chemical reaction between the first fluid and the second fluid. In thruster system 100b, the energy released in the chemical reaction between the first fluid and the second fluid may be converted into kinetic or thermal energy of the first fluid, the second fluid, and/or the product exiting the cavity via the nozzle 176b to generate thrust.

Generally, identical reference labels that are shared between different figures herein indicate that the elements so labeled may be the same (e.g., the tank 140 in FIG. 1A and the tank 140 in FIG. 1B). However, while FIG. 1B uses certain reference labels that are shared with FIG. 1A, it is understood that the corresponding elements of the thruster system 100b may or may not be of the same type as those in the thruster system 100a. For example, while “EM source 140” is shown in both FIG. 1A and FIG. 1B, some embodiments of the thruster system 100b may use an EM source that is specifically optimized for (e.g., is specifically designed for, and/or has control settings that are specifically optimized for, etc.) a thruster that incorporates both chemical and electrothermal propulsion techniques.

FIGS. 2 and 3 schematically illustrate example embodiments of the chemical decomposition unit 182 using electrolysis. The first fluid and the second fluid in electrolysis-based embodiments may be oxygen and hydrogen, respectively. In such an embodiment, the source material may be water stored in the tank 110 of thruster system 100b in any suitable phase or mixture of phases. FIG. 2 illustrates an example embodiment of the chemical decomposition unit 182 using proton exchange membrane (PEM) electrolysis. FIG. 3, on the other hand, illustrates an example embodiment of the chemical decomposition unit 182 using steam electrolysis. Additionally or alternatively, the systems described in the present disclosure may use photo-electrolysis, thermal electrolysis, or any other suitable electrolysis method. Furthermore, other methods of chemical decomposition may be implemented is some embodiments instead of, or in addition to, electrolysis. For example, a method of chemical decomposition may include catalysis (e.g., using a tungsten catalyst bed for hydrazine or ammonia).

In FIG. 2, an electrolysis unit 282 may be an embodiment of the chemical decomposition unit 182 of FIG. 1B. The electrolysis unit 282 may take in (receive as input) an input stream 225, directed, for example from the tank 110. A controller (not shown in FIG. 1B or FIG. 2) may control flow rate of the input stream 225, e.g., by controlling a pump, a valve, etc.

The electrolysis unit 282 may be electrically connected to a power supply 234, which may be included in the power unit 130. The power supply 234 may include a battery, a capacitor, a solar cell, a solar collector, a fuel cell, a micro turbine, and/or any other device suitable for generating, storing, and/or supplying power.

In operation, the electrolysis unit 282 may take in the stream 225 containing liquid propellant and generate output streams 235a and 235b. In some embodiments, the accumulation tanks 184 and 186 accumulate the respective fluids present in the output streams 235a and 235b. The output streams 235a and 235b may include, respectively, the first fluid and the second fluid. In an example embodiment, the stream 235a is a stream of a first gas that is a decomposition product of electrolysis of the liquid propellant, while the stream 235b is a stream of a second gas that is another, different decomposition product of electrolysis, with the latter being mixed with remaining source material. In another embodiment, the electrolysis unit 282 may be configured to fully decompose the liquid propellant in the stream 225, and the output streams 235a, b each carry solely the respective gas product of the decomposition. To that end, a controller (not shown in FIG. 1B or FIG. 2) may control the rate of flow of the liquid propellant to the electrolysis unit 282 and/or the rate of electrolysis. The controller may control the rate of electrolysis, for example, by controlling the amount of power that the power supply 234 supplies to the electrolysis unit 282.

The example electrolysis unit 282 includes a proton exchange membrane 287 (PEM) disposed between an anode 286 and a cathode 288. The PEM 287 may be implemented as a polymer electrolyte membrane, for example. Generally, any membrane conductive to protons, but not conductive to electrons or negatively charged ions, may be used. The PEM 287 may be constructed with pure polymer, composite, or other materials embedded in a polymer matrix. The polymers may be poly-aromatic polymers, fully or partially fluorinated polymers, or any other suitable polymers.

In operation, a proton generating reaction may take place at the anode 286 side of the PEM 287 of the electrolysis unit 282. Subsequently, the generated protons may travel toward the cathode 288 of the electrolysis unit 282, recombine with electrons, and form, for example, hydrogen gas (e.g., if the liquid propellant is water or hydrazine). The electrolysis unit 282 may then channel the generated hydrogen gas into an output stream (e.g., the output stream 235a).

In embodiments where the source material is water, the anode 286 side reaction produces oxygen gas that may mix with the water stream. The electrolysis unit 282 may channel the oxygen enriched water stream into an output stream (e.g., the output stream 235b). In some embodiments, a gas transfer unit may be included in the conversion unit 180 to recirculate the liquid propellant (water) in the output stream 235b back into the tank 110. Prior to recirculating water into the tank 110, the gas transfer unit may remove oxygen from the water stream. The oxygen removed from the water stream may be directed into an accumulation tank (e.g., tank 184 or 186, depending which tank is intended for oxygen storage).

In some embodiments, the source material is hydrazine and the anode 286 side reaction produces nitrogen gas that mixes with the hydrazine stream. The electrolysis unit 282 may channel the nitrogen enriched hydrazine stream into an output stream (e.g., the output stream 235b). A gas transfer unit may recirculate the source material (hydrazine) in the output stream 235b back into the tank 110. Prior to recirculating hydrazine into the tank 110, the gas transfer unit may remove nitrogen from the hydrazine stream. The nitrogen removed from the hydrazine stream may be directed into an accumulation tank (e.g., tank 184 or 186, depending which tank is intended for nitrogen storage).

More generally, techniques described in this disclosure may apply to any suitable liquid propellant or another source material. In the context of FIG. 2, the electrolysis unit 282 may decompose other liquid propellants with hydrogen as a decomposition product. Even more generally, the chemical decomposition unit 230 may use a solid state membrane selectively conductive for one of the intermediate ionic products of chemical decomposition, at either an anode or a cathode, in place of the PEM 287 to enable electrolysis.

In FIG. 3, a chemical decomposition unit 382 may be an embodiment of the chemical decomposition unit 182 of FIG. 1. The example chemical decomposition unit 382 is configured for high temperature electrolysis. In embodiments where the source material is water, the high temperature electrolysis may be referred to as “steam electrolysis.”

The chemical decomposition unit 382 includes a heater 384, which may also be referred to as a vaporizer 384, and an electrolysis unit 385. Both the heater 384 and the electrolysis unit 385 may receive power from a power supply 334, which may be included in the power unit 130. That is, the power supply 334 may be configured to provide power to the heater 384 as well as to the electrolysis unit 385. In other embodiments, however, there are separate power supplies for the heater 384 and the electrolysis unit 385. The power supply 334 may include a battery, a capacitor, a solar cell, a solar collector, a fuel cell, a micro turbine, and/or any other device suitable for generating, storing, and/or supplying power.

The heater 384 is configured to be in thermal communication with an input stream 325, via, for example, a heat exchanger. In operation, the chemical decomposition unit 382 may take in an input stream 325 including a source material (e.g., liquid propellant) from the tank 110 of the thruster system 100b via one or more pumps and/or one or more valves controlled by a controller (not shown in FIG. 1B or FIG. 3). The heater 384 may transfer heat to, and thereby vaporize, the input stream 325. A vaporized stream 328 may then flow into the electrolysis unit 385. The electrolysis unit 385 may take in the stream 328 containing vaporized source material and generate output streams 335a and 335b. The output streams 335a and 335b, which may include the first fluid and the second fluid (respectively) configured to chemically react within the thruster cavity 172b, may be directed to the accumulation tanks 184 and 186, respectively.

In an example embodiment, the stream 335a is a stream of a gas that is a decomposition product of electrolysis of the vaporized source material, while the stream 335b is a stream of another gas that is a another, different decomposition product of electrolysis and mixed with the remaining vaporized source material (e.g., liquid propellant). In another embodiment, the electrolysis unit 385 is configured to fully decompose the vaporized source material in the stream 325, in which case the output streams 335a, b each carry solely a different, respective gas product of the decomposition. To that end, a controller (not shown in FIG. 1B or FIG. 3) may control the rate of flow of the liquid propellant past the heater 384 to the electrolysis unit 385. Simultaneously, the controller may control the amount of heat that the heater 384 transfers to the source material stream 325, for example, by controlling the amount of power that the power supply 334 supplies to the heater 384. Additionally or alternatively, the controller may control the rate of electrolysis, for example, by controlling the amount of power that the power supply 334 supplies to the electrolysis unit 385.

The electrolysis unit 385 may be configured for high temperature electrolysis. To that end, the electrolysis unit 385 may include an anode, a cathode, and a solid-state electrolyte membrane. The anode and the cathode may be porous to allow the flow of the vaporized propellant and the product gases produced by electrolysis. The electrolyte may be made of zirconia, ceramic, or another suitable material.

In embodiments where the source material is water, the anode side reaction produces oxygen gas. The cathode side reaction may produce hydrogen mixed with steam. The electrolysis unit 385 may channel oxygen into one output stream (e.g., the output stream 335a) and the hydrogen enriched water vapor stream into another output stream (e.g., the output stream 335b). In some embodiments, the chemical decomposition unit 382 may condense the vapor, generating an output stream (e.g., the output stream 335b) of hydrogen mixed in water. The system 100b, may separate hydrogen from the steam while condensing the vaporized source material, and recirculate the liquid source material (e.g., water) in the output stream 335b back into the tank 110. The mixed-in hydrogen may then serve as the first fluid and be accumulated in an accumulation tank (e.g., tank 184). Likewise, the oxygen generated by steam electrolysis may serve as the second fluid configured to react with the first fluid (e.g., hydrogen) and be accumulated in an accumulation tank (e.g., tank 186). Additionally or alternatively, at least some of the oxygen (or another gas) generated by electrolysis may be directed for another purpose, such as, for example, to pressurize the tank 110.

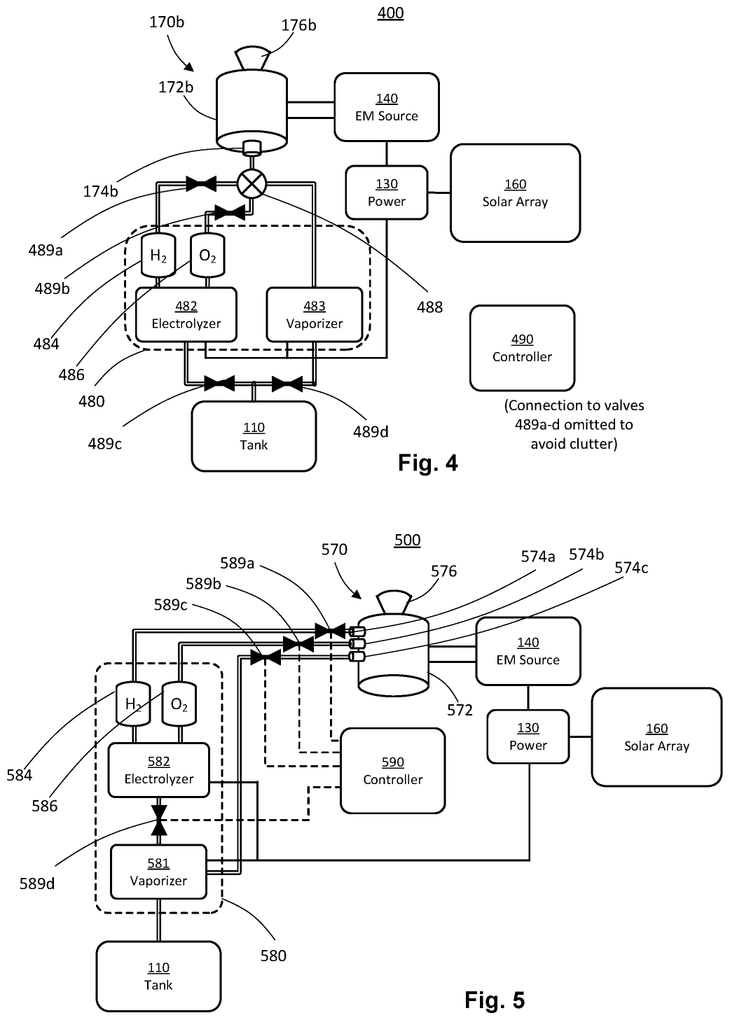

FIG. 4 schematically illustrates another example embodiment of a thruster system 400 based on chemical-MET propulsion. In the example system 400, the cavity 172b is configured to receive via the inlet 174b three fluids: hydrogen, oxygen, and water vapor. To that end, the system 400 includes a chemical conversion unit 480 in lieu of the conversion unit 180b of thruster system 100b. The conversion unit 480 includes an electrolyzer 482 (e.g., electrolysis unit 282) and a vaporizer 483. The electrolyzer 482 is in fluidic communication with accumulation tanks 484 and 486 for hydrogen and oxygen, and, via the accumulation tanks 484 and 486 with the combiner 488. The vaporizer 483 is in direct fluidic communication with the combiner 488. A series of valves 489a-d may control the flow from the accumulation tanks 484 and 486 to the combiner 488, as well as from the tank 110 to the electrolyzer 482 and the vaporizer 483 (valves 489c and 489d respectively). A controller 490 may be communicatively (e.g., by wires or wirelessly) connected to the valves 489a-c. Connections from the controller 490 to the valves 489a-d are not shown to avoid clutter. In some embodiments, the accumulation tanks 484 and 486 may be in direct fluidic communication with the cavity 172b via distinct inlets, omitting the combiner 488. The fluidic conduits between the tanks 484 and 486 and the cavity 172b may include valves communicatively connected to the controller 490 and controlled in a manner discussed below. Still in other embodiments, a combiner may only combine two of the three streams (i.e., from the hydrogen tank 484, from the oxygen tank 486, and the vaporizer 483) with the third stream fluidically connected directly to the cavity 172b via an inlet distinct from the inlet 174b.

In operation, hydrogen and oxygen may combust in the cavity 172b of the thruster 170b to generate chemical propulsion, and the water generated as a product of the combustion may mix with the water vapor exiting the vaporizer 483. The water may absorb energy emitted from the EM source 140. The water then ionizes to generate plasma and convert electromagnetic energy to kinetic energy, generating thermal propulsion.

In other embodiments, at the onset of the propulsion period, the cavity 172b may receive water vapor from the vaporizer 483. The water may absorb energy from the EM source 140 to generate plasma. Subsequently, the cavity 172b may receive hydrogen and oxygen sequentially or simultaneously. The hot plasma in the cavity 172b may accelerate combustion. Furthermore, the plasma may be confined to a particular region within the cavity 172b (e.g., due to inlet placement and/or circumferential flow), thereby accelerating combustion in that region.

In still other embodiments, the cavity 172b may receive hydrogen or oxygen at the onset of a propulsion period, and the ionization of the respective gas may generate the plasma.

Generally, a controller (e.g., controller 490) may control valves (e.g., valves 489a-c) to direct gases (or, in some embodiments, liquids) to a cavity (e.g., cavity 172b) of a thruster (e.g., thruster 170b) in any suitable order and at any suitable flow rates. For example, in system 400, based on the controller 490 implementing a control sequence for controlling valves 489a-d, the cavity 472b may receive hydrogen, oxygen, and water vapor with any suitable flow rate profiles with respect to time. Any of the gases or gas mixtures (of hydrogen, oxygen, and/or water) may be configured to generate plasma upon absorbing energy from the EM source 140. The gases or corresponding plasmas may transfer thermal (kinetic) energy to other gases, causing thermal expansion and, as a result, thermal propulsion. Additionally or alternatively, enthalpy accumulated in the gases may cause or accelerate chemical reactions among the materials within the cavity and cause or accelerate chemical propulsion.

FIG. 5 schematically illustrates another example embodiment of a thruster system 500 based on chemical-MET propulsion. The system 500 includes a thruster 570 with a cavity 572. The thruster 570 differs from the example thruster 170b in that the thruster 576 includes three inlets 574a-c. Generally, however, a thruster of the present disclosure may include any suitable number of inlets (one, two, three, etc.). Thruster 570 also includes a nozzle 576 which may be analogous to the nozzle 176b.

The positions of the three inlets 574a-c only schematically illustrate the presence of inlets for injecting fluids into the cavity 572, and should not be construed to limit inlet configurations in any way. More generally, inlets 574a-c may be disposed, together or separately, at any suitable location(s) of the cavity 572. In some implementations, any one or more of the inlets 574a-c may be located on the curved wall of a cylindrical cavity and proximal to a cavity-terminating plate housing a nozzle, or at a suitable distance from the cavity-terminating plate housing the nozzle. In some implementations, any one or more of the inlets 574a-c may be located on the cavity-terminating plate housing the nozzle, rather than a different cavity wall. Additionally, multiple inlets may be configured for injecting any one of the fluids into the cavity 572. For example, without loss of generality, two inlets may be configured to inject the first fluid, four inlets to inject the second fluid, and three inlets to inject the third fluid. Inlet geometry and/or locations at the cavity walls may serve a variety of functions: creating rotational flow to stabilize plasma, positioning the epicenter of a chemical reaction at a suitable location within the cavity (e.g., near a nozzle), creating density gradients within the cavity to control ionization or combustion, etc.

Furthermore, multiple inlet configurations of the sort described above may be used within PEM or steam electrolysis-fed systems or, more generally, with any other system where multiple fluids are injected into a thruster cavity (e.g., cavity 572). Any conduits feeding combiners (e.g., combiners 188 or 488) may instead connect directly to the cavity via suitable inlet configurations. For example, a combiner may combine two fluids (e.g., hydrogen and water) prior to injecting the mixture into the cavity, while an inlet connected directly to the cavity may inject the third fluid (e.g., oxygen).

The system 500 further includes a chemical conversion unit 580 in fluidic communication with the tank 110 and the cavity 572 (via the inlets 574a-c). The chemical conversion unit 580 includes a vaporizer 581, an electrolyzer 582 (e.g., high temperature electrolyzer 385 as described in FIG. 3), and accumulation tanks 584 and 586, respectively, for hydrogen and oxygen. The vaporizer 581 and electrolyzer 582 may each receive power from the power unit 130. The system 500 may further include a set of valves 589a-d and a controller 590 in communicative connection with the valves 589a-d.

In operation the vaporizer 581 may receive the liquid water from the tank 110 and vaporize the received water to generate steam. The controller 590 may control valves 589c,d to direct the generated steam to the cavity 572 and electrolyzer 582, respectively. In one embodiment or mode of operation, the controller 590 may direct a larger portion of the steam generated in the vaporizer 581 into the cavity 572. In another embodiment or mode of operation, the controller 590 may direct a larger portion of the steam generated in the vaporizer 581 into the electrolyzer 582. The electrolyzer 582 may decompose the steam received from the vaporizer 581 into hydrogen and oxygen, using high temperature electrolysis (e.g., as described with reference to FIG. 3), and direct the decomposition products into the accumulation tanks 584 and 586, respectively.

Similar to the discussion with reference to FIG. 4, the controller 590 may direct, using valves 589a-c, hydrogen, oxygen, and/or steam into the cavity 572 in any suitable order and with any suitable flow rates. The inlets 574a-c may be configured so as to create circumferential flow of at least one of the fluids injected into the cavity 572.

In some embodiments or operating modes, a combustion reaction of hydrogen and oxygen may generate water vapor and, subsequently, the EM source 140 may deliver energy to ionize the water vapor generated in combustion. In other embodiments or operating modes, the EM source 140 may deliver energy to ionize the water vapor received from the vaporizer 581 via the inlet 574c, and the generated plasma may accelerate and/or spatially confine combustion of the subsequently injected hydrogen and oxygen.

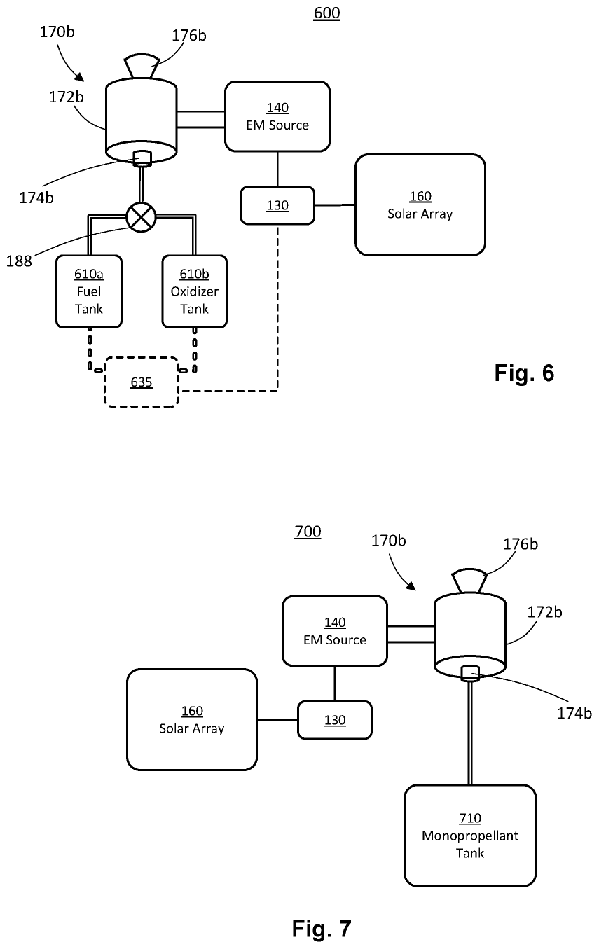

FIG. 6 schematically illustrates an example generalized embodiment of a thruster system 600 based on chemical-MET propulsion. The system 600 includes a fuel tank 610a and an oxidizer tank 610b. In some embodiments, the fuel in the fuel tank 610a is hydrogen and the oxidizer in the oxidizer tank 610b is oxygen. More generally, however, the tanks 610a,b may hold any suitable fuel (e.g., a variety of hydrocarbons such as propylene, methane, kerosene, as well as hydrazine, ammonia, etc.) and oxidizer (e.g., peroxide, fluorine, tetrafluoro-hydrazine, nitrous oxide, etc.), respectively. In system 600, the fuel and the oxidizer need not be generated by chemically decomposing the source material. In some embodiments, the tanks 610a,b may hold the fuel and the oxidizer prior to launch of the space vehicle.

In some embodiments, the tanks 610a and 610b may be in direct fluidic communication with the cavity 172b via distinct inlets, omitting the combiner 188. The fluidic conduits between the tanks 610a and 610b and the cavity 172b may include valves controlled by a controller, as discussed in more detail above with reference to FIG. 5.

In operation, the cavity 172b of the thruster 170b may initially receive either the fuel or the oxidizer. The fluid received by the cavity 172b may absorb the electromagnetic energy from the source 140 to generate plasma. In one embodiment or operating mode, for example, the cavity 172b first receives fuel from the tank 610a, which ionizes upon absorbing electromagnetic energy from the source 140, and subsequently receives an oxidizer from the tank 610b. The ionized fuel may then readily react with the oxidizer, producing thrust. In another embodiment or operating mode, the cavity 172b first receives oxidizer from the tank 610b, which may ionize upon absorbing electromagnetic energy from the source 140, and subsequently receives fuel from the tank 610b. The ionized oxidizer may then readily react with the fuel, producing thrust. In yet another embodiment, the cavity 172b simultaneously receives fuel and oxidizer from the tanks 610a and 610b, respectively, which may react without the energy input from the source 140 to generate thrust. The source 140 then subsequently adds electromagnetic energy to the reaction products (e.g., steam, carbon dioxide, etc.) to generate additional thrust.

FIG. 7 schematically illustrates an example embodiment of a thruster system 700 based on chemical-MET propulsion using monopropellant decomposition. To that end, the system 700 may include a monopropellant tank 710, configured to hold a monopropellant (e.g., hydrazine, hydrogen peroxide, nitrous oxide, a “green” monopropellant such as minor propellants based on Hydroxyl Ammonium Nitrate or HAN, etc.). The cavity 172b may receive the monopropellant via the inlet 174b, or via multiple inlets. The monopropellant injected into the cavity 172b then absorbs electromagnetic energy from the EM source 140. The electromagnetic energy absorbed from the EM source 140 may accelerate the decomposition of the monopropellant within the cavity 172b to generate additional thrust, beyond what would be achieved by the decomposition alone. In other embodiments or operating modes, the cavity 172b receives the monopropellant, which subsequently chemically decomposes to generate one or more decomposition products. A decomposition product may then absorb energy from the source 140, generating electrothermal thrust. In still other embodiments, plasma generated by absorbing energy from the source 140 initiates, accelerates, and/or confines the decomposition of the monopropellant within the cavity 172b.

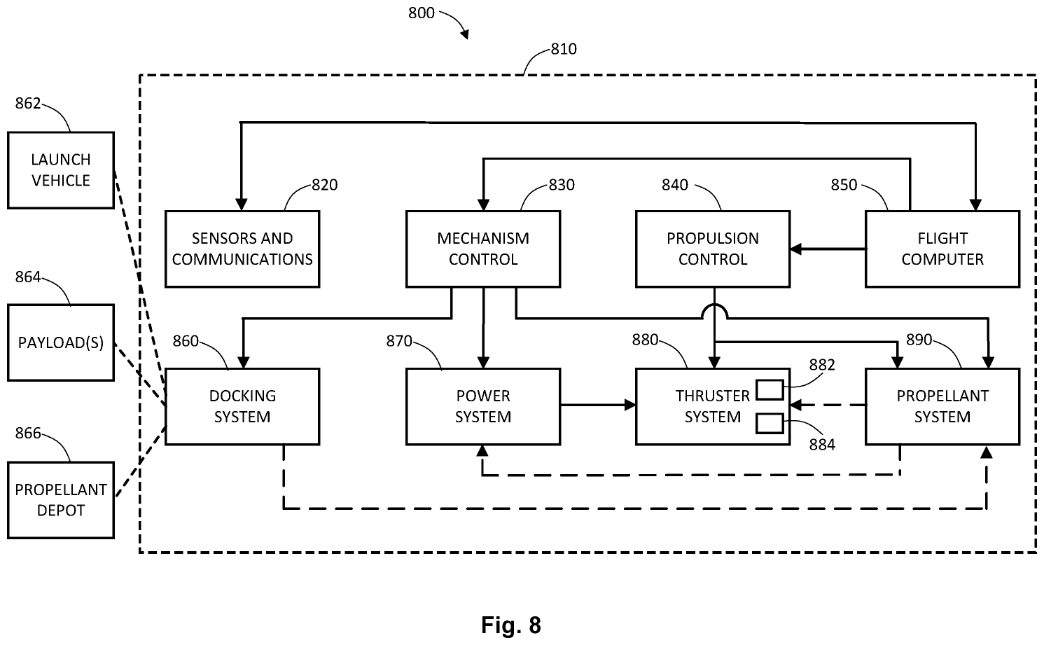

FIG. 8 is a block diagram of a spacecraft 800 configured for transferring a payload between orbits in which portions of thruster systems (e.g., systems 100a, b, 400, 500, 600, or 700) may operate. The thruster modes, the propellant use, the environmental condition of the tank 110, and, consequently, the operation of the systems 100a, b, 400, 500, 600, and 700, may interact with a variety of parameters of operation of the spacecraft 800.

The spacecraft 800 includes a number of systems, subsystems, units, or components disposed in, on, and/or coupled to a housing 810. The subsystems of the spacecraft 800 may include sensors and communications components 820, mechanism control 830, propulsion control 840 (which may, for example, include controllers for 490 and 590), a flight computer 850, a docking system 860 (for attaching to a launch vehicle 862, one or more payloads 864, a propellant depot 866, etc.), a power system 870, a thruster system 880 that includes a primary propulsion (main) thruster subsystem 882 and an attitude adjustment thruster subsystem 884 each of which may include the systems 100a,b, 400, 500, 600, or 700 of the present disclosure, and a propellant system 890. Furthermore, any combination of subsystems, units, or components of the spacecraft 800 involved in determining, generating, and/or supporting spacecraft propulsion (e.g., the mechanism control 830, the propulsion control 840, the flight computer 850, the power system 870, the thruster system 880, and the propellant system 890) may be collectively referred to as a propulsion system of the spacecraft 800.

The sensors and communications components 820 may include a number of sensors and/or sensor systems for navigation (e.g., imaging sensors, magnetometers, inertial motion units (IMUs), Global Positioning System (GPS) receivers, etc.), temperature, pressure, strain, radiation, and other environmental sensors, as well as radio and/or optical communication devices to communicate, for example, with a ground station, and/or other spacecraft. The sensors and communications components 820 may be communicatively connected with the flight computer 850, for example, to provide the flight computer 850 with signals indicative of information about spacecraft position and/or commands received from a ground station.

The flight computer 850 may include one or more processors, a memory unit, computer readable media, to process signals received from the sensors and communications components 820 and determine appropriate actions according to instructions loaded into the memory unit (e.g., from the computer readable media). Generally, the flight computer 850 may be implemented using any suitable processing hardware, such as, for example, a digital signal processing (DSP) circuit, an application-specific integrated circuit (ASIC), a field programmable gate array (FPGA), and/or a microprocessor configured to executed software instructions stored in a memory unit. More generally, the flight computer 850 may be implemented with any suitable electronic hardware and/or software components. The flight computer 850 may generate control messages based on the determined actions and communicate the control messages to the mechanism control 830 and/or the propulsion control 840. For example, upon receiving signals indicative of a position of the spacecraft 800, the flight computer 850 may generate a control message to activate one of the thruster subsystems 882, 884 in the thruster system 880 and send the message to the propulsion control 840. The flight computer 850 may also generate messages to activate and direct sensors and communications components 820. For example, the flight computer 850 may interact with the controllers 490 and 590 described above.

The docking system 860 may include a number of structures and mechanisms to attach the spacecraft 800 to a launch vehicle 862, one or more payloads 864, and/or a propellant refueling depot 866. The docking system 860 may be fluidicly connected to the propellant system 890 to enable refilling the propellant from the propellant depot 866. Additionally or alternatively, in some embodiments at least a portion of the propellant may be disposed on the launch vehicle 862 and outside of the spacecraft 800 during launch. The fluidic connection between the docking system 860 and the propellant system 890 may enable transferring the propellant from the launch vehicle 862 to the spacecraft 800 upon delivering and prior to deploying the spacecraft 800 in orbit.

The power system 870 (which may include the power unit 130, the power supplies 234, 334, power plant 635, and the solar array 160) may include components for collecting solar energy, generating electricity and/or heat, storing electricity and/or heat, and delivering electricity and/or heat to the thruster system 880. To collect solar energy, the power system 870 may include solar panels (e.g., solar array 160) with photovoltaic cells, solar collectors or concentrators with mirrors and/or lenses, or a suitable combination of devices. In the case of using photovoltaic devices, the power system 870 may convert the solar energy into electricity and store it in energy storage devices (e.g., lithium ion batteries, fuel cells, etc.) for later delivery to the thruster system 880 and other spacecraft components. In some embodiments, the power system 880 may deliver at least a portion of the generated electricity directly (i.e., bypassing storage) to the thruster system 880 and/or to other spacecraft components. When using a solar concentrator, the power system 870 may direct the concentrated (having increased irradiance) solar radiation to photovoltaic solar cells to convert to electricity. In other embodiments, the power system 870 may direct the concentrated solar energy to a solar thermal receiver or simply, a thermal receiver, that may absorb the solar radiation to generate heat. Still furthermore, using a solar concentrator, the power system 870 may perform electrolysis for generating chemical components for propulsion as described above. The power system 870 may use the generated heat to power a thruster directly and/or to generate electricity using, for example, a turbine or another suitable technique (e.g., a Stirling engine). The power system 870 then may use the electricity directly for generating thrust or storing electrical energy.

The thruster system 880 may include a number of thrusters (e.g., thrusters 170b or 570) and other components configured to generate propulsion or thrust for the spacecraft 800. Thrusters may generally include main thrusters in the primary propulsion subsystem 882 that are configured to substantially change speed of the spacecraft 800, or as attitude control thrusters in the attitude control thruster subsystem 884 that are configured to change direction or orientation of the spacecraft 800 without substantial changes in speed.

One or more thrusters in the primary propulsion subsystem 882 may be MET thrusters. In a MET thruster cavity, an injected amount of propellant (e.g., delivered via the liquid propellant transfer unit 120) may absorb energy from a microwave source (that may include one or more oscillators) included in the thruster system 880 and, upon partial ionization, further heat up, expand, and exit the MET thruster cavity through a nozzle, generating thrust.

Another one or more thrusters in the primary propulsion subsystem 882 may be solar thermal thrusters. In one embodiment, propellant in a thruster cavity acts as the solar thermal receiver and, upon absorbing concentrated solar energy, heats up, expands, and exits the nozzle generating thrust. In other embodiments, the propellant may absorb heat before entering the cavity either as a part of the thermal target or in a heat exchange with the thermal target or another suitable thermal mass thermally connected to the thermal target. In some embodiments, while the propellant may absorb heat before entering the thruster cavity, the primary propulsion thruster subsystem 882 may add more heat to the propellant within the cavity using an electrical heater or directing a portion of solar radiation energy to the cavity.

Other types of thrusters may also be used. For example, the primary propulsion subsystem 882 may also, or instead, include one or more combustion thrusters that consume one or more electrolysis products (e.g., electrolysis products generated by an electrolysis unit that is larger scale, and perhaps utilizes a different electrolysis technique, than the electrolysis unit discussed above in connection with generating the tank pressurant).

Thrusters in the attitude adjustment subsystem 884 may use propellant that absorbs heat before entering the cavities of the attitude adjustment thrusters in a heat exchange with the thermal target or another suitable thermal mass thermally connected to the thermal target. In some embodiments, while the propellant may absorb heat before entering thruster cavities, the thrusters of the attitude adjustment thruster subsystem 884 may add more heat to the propellant within the cavity using corresponding electrical heaters. Likewise, propellant may be evaporated in heat exchangers prior to the supply of propellant into high temperature electrolysis units (e.g., unit 382). Thus, the vaporizer 384 of FIG. 3, as well as vaporizers 483 and 581 of FIGS. 4 and 5, respectively, may interact with other thermal elements of the spacecraft 800.

The propellant system 890 may store the propellant for consumption in the thruster system 880. The propellant may include water, hydrogen peroxide, hydrazine, ammonia, or another suitable substance. The propellant may be stored on the spacecraft in solid, liquid, and/or gas phase. To that end, the propellant system 890 may include one or more tanks (e.g., tank 110, tanks 610a, b, tank 710, tanks 184, 186, 484, 486, 584, 586), including, in some embodiments, deployable tanks. To move the propellant within the spacecraft 800, and to deliver the propellant to one of the thrusters, the propellant system 890 may include one or more pumps, valves, and pipes. The propellant may also store heat and/or facilitate generating electricity from heat, and the propellant system 890 may be configured, accordingly, to supply propellant to the power system 870. In some embodiments, one or more electrolysis units (e.g., unit 282, 385, 482, 582) of this disclosure may be configured to run in reverse as fuel cells to generate electricity.

The mechanism control 830 may activate and control mechanisms in the docking system 860 (e.g., for attaching and detaching a payload or connecting with an external propellant source), the power system 870 (e.g., for deploying and aligning solar panels or solar concentrators), and/or the propellant system 890 (e.g., for changing the configuration of one or more deployable propellant tanks). Furthermore, the mechanism control 830 may coordinate interaction between subsystems, for example, by deploying a tank in the propellant system 890 to receive propellant from an external propellant source connected to the docking system 860.

The propulsion control 840 may coordinate the interaction between the thruster system 880 and the propellant system 890, for example, by activating and controlling electrical components (e.g., a microwave source) of the thruster system 840 and the flow of propellant supplied to thrusters by the propellant system 890. Additionally or alternatively, the propulsion control 840 may direct the propellant through elements of the power system 870. For example, the propellant system 890 may direct the propellant to absorb the heat (e.g., at a heat exchanger) accumulated within the power system 870. Vaporized propellant may then drive a power plant (e.g., a turbine, a Stirling engine, etc.) of the power system 870 to generate electricity. Additionally or alternatively, the propellant system 890 may direct some of the propellant to charge a fuel cell within the power system 890. Still further, the attitude adjustment thruster subsystem 884 may directly use/consume the heated propellant to generate thrust.

The subsystems of the spacecraft 800 may be merged or subdivided in different embodiments. For example, a single control unit may control mechanisms and propulsion. Alternatively, dedicated controllers may be used for different mechanisms, thrusters (e.g., including a thruster of the present disclosure), valves, etc. In the preceding discussion, a “controller” may refer to any portion or combination of the mechanism control 830 and/or propulsion control 840.

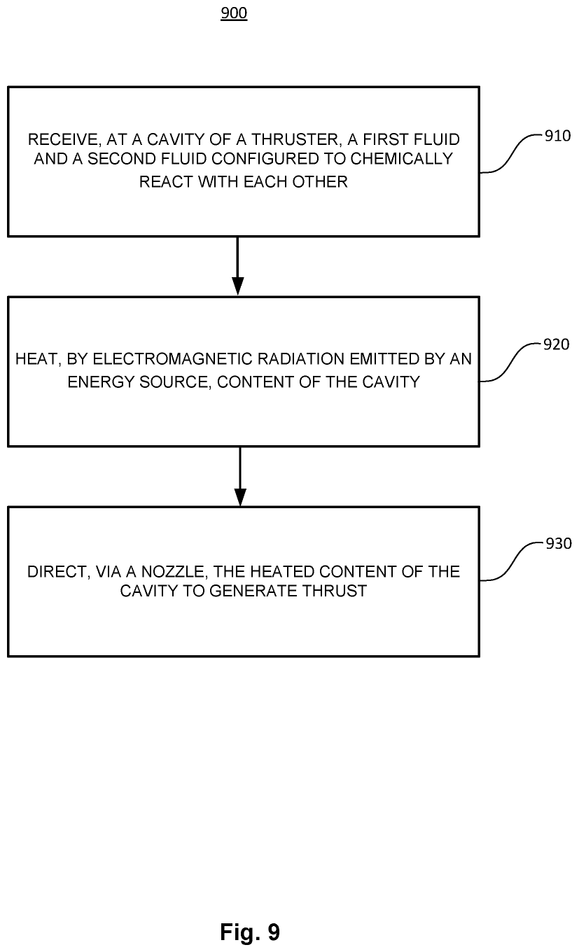

FIG. 9 illustrates an example method 900 of spacecraft propulsion using a combination of electrothermal and chemical propulsion. The method 900 may be performed by a thruster system (e.g., system 100b, 400, 500, 600, or 700) of this disclosure.

At block 910, the method 900 includes receiving at a cavity (e.g., cavity 172b, 572) a first fluid and the second fluid configured to chemically react with each other to generate a reaction product. The cavity may receive the first fluid and the second fluid via a single inlet (e.g., inlet 174b) or a plurality of inlets (e.g., inlets 574a-c). A controller (e.g., controller 490, 590) may control the flow rates of the first fluid and the second fluid into the cavity using one or more valves (e.g., valves 489a-d, valves 589a-d).

In some embodiments, the method 900 may include generating the first fluid and the second fluid by chemically decomposing a source material (e.g., systems 100b, 400, 500). In other embodiments, separate tanks (e.g., tanks 610a, b) may be filled with the first fluid and the second fluid before launch or any suitable time, without decomposing the source material.

In some embodiments (e.g., systems 400, 500), the source material may be water, while the first and the second fluid may be oxygen and hydrogen. The water may be decomposed into hydrogen and oxygen using electrolysis (e.g., systems 400, 500). More generally, electrolysis may be used to decompose other source materials to generate the first and the second fluids. In some embodiments, PEM electrolysis (e.g., as discussed with respect to FIG. 3) may be used. In other embodiments, high temperature electrolysis (e.g., as discussed with respect to FIG. 4 may be used).

In some embodiments, the method 900 may include vaporizing the source material. The cavity may be configured to receive the vaporized source material. Additionally or alternatively, a unit performing high temperature electrolysis may receive the source material vaporized by a vaporizer. In some embodiments, the electrolysis unit and the cavity may receive vaporized source material vaporized by the same vaporizer, thereby reducing complexity of the system (e.g., system 500).

At block 920, the method 900 may include heating or ionizing by electromagnetic radiation emitted by an energy source (e.g., EM source 140) coupled to the cavity the content of the cavity. At a given time during an implementation of the method 900, the content of the cavity may include at least one of: the first fluid, the second fluid, and the reaction product of the first fluid and the second fluid. In some embodiments, the method may include heating the source material from which the first fluid and the second fluid are generated (e.g., using electrolysis) as discussed above.

The method 900 may include a controller (e.g., controller 590) to control flow rates of the first fluid, the second fluid, and the source material into the cavity. The controller may control the flow of materials into the cavity so as to use one of the materials (e.g., the first fluid, the second fluid, or the source material) to generate plasma by absorbing electromagnetic radiation from an energy source (e.g., source 140). The resulting plasma may accelerate and/or confine the reaction between the first fluid and the second fluid to a region of the cavity. Furthermore, the method may include injecting one or more fluids into the cavity to generate circumferential flow of the first fluid, the second fluid, and/or the source material to stabilize the generated plasma. For example, circumferential flow of oxygen may stabilize the plasma generated from the water vapor, while injected hydrogen may be confined to the center of the cavity and react with the oxygen and/or the plasma from the water vapor. Injecting fluids to generate circumferential flow may include configuring inlets to induce circumferential flow and/or controlling pressure differential across inlets using valves controlled by a controller.

At block 930, the method 900 may include directing via a nozzle (e.g., nozzle 176, 576, or 676) the heated content of the cavity to generate thrust. To that end, the method 900 may include increasing enthalpy or kinetic energy of at least a portion of the content (e.g., first fluid, the second fluid, and/or the reaction product) using the combination of chemical energy released during the reaction between the first fluid and the second fluid and the electromagnetic energy absorbed from the source. In some embodiments, the method 900 may include adding the source material from which the first fluid and the second fluid are generated by chemical decomposition, as discussed above. The source material may therefore heat up, after absorbing energy from the chemical reaction between the first fluid and the second fluid or the electromagnetic source, and exit through the nozzle to generate thrust.

1. A thruster system for use in a spacecraft, the thruster system comprising:
a cavity including at least one inlet to receive a first fluid and a second fluid configured to chemically react with the first fluid within the cavity to generate a reaction product;
an energy source coupled to the cavity and configured to heat content of the cavity by emitting electromagnetic radiation; and
a nozzle provided at one end of the cavity and configured to direct the heated cavity content out of the cavity to generate thrust.

2. The thruster system of claim 1, further comprising:
a chemical decomposition unit configured to generate the first fluid and the second fluid by chemically decomposing a source material.

3. The thruster system of claim 2, wherein:
the chemical decomposition unit includes an electrolysis unit configured to generate the first fluid and the second fluid by electrolysis of the source material.

4. The thruster system of claim 3, wherein:
the electrolysis unit includes a proton exchange membrane (PEM).

5. The thruster system of claim 3, wherein:
the chemical decomposition unit includes a vaporizer configured to generate vapor by vaporizing the source material;
the electrolysis unit is configured to receive a first portion of the generated vapor; and
the cavity is configured to receive a second portion of the generated vapor.

6. The thruster system of claim 3, wherein:
the first fluid is oxygen;
the second fluid is hydrogen; and
the source material is water.

7. The thruster system of claim 2, further comprising:
a vaporizer configured to vaporize the source material; and
a controller configured to control flow rates of the first fluid, the second fluid, and the vaporized source material into the cavity.

8. The thruster system of claim 7, wherein:
the at least one inlet includes a first inlet, a second inlet, and a third inlet; and
the cavity is configured to receive the first fluid via the first inlet, the second fluid via the second inlet, and the vaporized source material via the third inlet.

9. The thruster system of claim 1, wherein:
the energy source is configured to ionize cavity content to generate plasma; and
the at least one inlet is configured to generate circumferential flow within the cavity to stabilize the plasma.

10. A thruster system for use in a spacecraft, the thruster system comprising:
a cavity including at least one inlet to receive a monopropellant configured to chemically decompose within the cavity to generate a plurality of decomposition products;
an energy source coupled to the cavity and configured to heat and ionize at least one of the plurality of decomposition products or the monopropellant by emitting electromagnetic radiation; and
a nozzle provided at one end of the cavity and configured to direct at least one of the plurality of decomposition products out of the cavity to generate thrust.

11. A method of spacecraft propulsion comprising:
receiving at a cavity via at least one inlet a first fluid and a second fluid configured to chemically react with the first fluid within the cavity to generate a reaction product;
heating content of the cavity by electromagnetic radiation emitted by an energy source coupled to the cavity; and
directing, via a nozzle, the heated content out of the cavity to generate thrust.

12. The method of claim 11, further comprising:
generating the first fluid and the second fluid by chemically decomposing a source material within a chemical decomposition unit.

13. The method of claim 12, wherein:
generating the first fluid and the second fluid by chemically decomposing the source material includes generating the first fluid and the second fluid by electrolysis of the source material within an electrolysis unit.

14. The method of claim 13, wherein:
generating the first fluid and the second fluid by electrolysis the includes using a proton exchange membrane (PEM).

15. The method of claim 13, further comprising:
vaporizing the source material using a vaporizer;
receiving a first portion of the vaporized source material at the electrolysis unit; and
receiving a second portion of the vaporized source material at the cavity.

16. The method of claim 13, wherein:
the first fluid is oxygen;
the second fluid is hydrogen; and
the source material is water.

17. The method of claim 12, further comprising:
vaporizing the source material using the vaporizer;
receiving the vaporized source material at the cavity via the one or more inlets; and
controlling, using a controller, flow rates of the first fluid, the second fluid, and the vaporized source material into the cavity.

18. The method of claim 17, further comprising:
injecting the first fluid, the second fluid, or the vaporized source material so as to create circumferential flow within the cavity.

19. The method of claim 17, further comprising:
ionizing the vaporized source material within the cavity to accelerate the chemical reaction between the first fluid and the second fluid.

20. The method of claim 11, further comprising:
ionizing the first fluid within the cavity prior to receiving the second fluid at the cavity.
